(19) United States
(12) Patent Application Publication
(10) Pub. No.: US 2021/0197471 A1
(43) Pub. Date: Jul. 1, 2021

(54) THREE-DIMENSIONAL PRINTER WITH CONVEYANCE

(71) Applicant: HEWLETT-PACKARD DEVELOPMENT COMPANY, L.P., Spring, TX (US)

(72) Inventors: Wesley R. SCHALK, Vancouver, WA (US); Kris M. ENGLISH, Vancouver, WA (US); Justin M. ROMAN, Vancouver, WA (US); Kevin E. SWIER, Corvallis, OR (US); David R. OTIS, Jr., Corvallis, OR (US)

(73) Assignee: HEWLETT-PACKARD DEVELOPMENT COMPANY, L.P., Spring, TX (US)

(21) Appl. No.: 16/077,057

(22) PCT Filed: Jul. 28, 2017
(86) PCT No.: PCT/US2017/044346

§ 371 Date: Aug. 10, 2018

(51) Int. Cl. B29C 64/321; B29C 64/259; B29C 64/357; B33Y 10/00; B33Y 30/00; B33Y 40/00

(52) U.S. Cl. CPC B29C 64/321; B29C 64/259; B33Y 40/00; B33Y 10/00; B33Y 30/00; B29C 64/357

(57) ABSTRACT

A 3D printer and method include a cartridge receiver to hold a material cartridge that accepts build material into the material cartridge from the 3D printer and makes build material available from the material cartridge. A first conveying system of the 3D printer transports build material for the 3D printing. A second conveying system of the 3D printer facilitates recovery of excess build material from the 3D printing.

### BACKGROUND

Additive manufacturing (AM) may include three-dimensional (3D) printing to form 3D objects. In particular, a 3D printer may add successive layers of build material, such as powder, to a build platform. The 3D printer may selectively solidify portions of each layer under computer control to produce the 3D object. The material may be powder, or powder-like material, including metal, plastic, composite material, and other powders. The objects formed can be various shapes and geometries, and produced via a model such as a 3D model or other electronic data source. The fabrication may involve laser melting, laser sintering, electron beam melting, or thermal fusion, and so on. The model and automated control may facilitate the layered manufacturing and additive fabrication. As for products, AM may fabricate intermediate and end-use products, as well as prototypes.

### DESCRIPTION OF THE DRAWINGS

Certain examples are described in the following detailed description and in reference to the drawings, in which:

FIGS. 1A-3 are block diagrams of 3D printers in accordance with examples of the present techniques;

FIG. 4 is a schematic diagram of a 3D printer in accordance with examples of the present techniques;

FIGS. 5 and 6 are block diagrams of 3D printers in accordance with examples of the present techniques;

FIGS. 7A and 7B are block flow diagrams of methods of operating a 3D printer in accordance with examples of the present techniques; and

FIG. 8 is a block diagram of an AM system in accordance with examples of the present techniques.

### DETAILED DESCRIPTION

The cost of a 3D printer producing 3D objects may be related, at least in part, to the cost of the build material. In addition, increased costs may result from employing dedicated resources external to the printer, extra floor space for supporting operation of the printer, and external equipment that may be utilized with some printers for mixing and extraction of build material.

Examples of the present techniques may be directed to a 3D printer having a cartridge receiver, e.g., slot, receptacle, cavity, etc., to receive a material cartridge. The 3D printer may supply material from the material cartridge as build material for printing. The 3D printer may also receive material into the material cartridge, such as excess build material from the 3D printing. The 3D printer may include more than one cartridge receiver. For instance, the aforementioned cartridge receiver may be a recycle cartridge receiver and with the material cartridge as a recycle material cartridge. The 3D printer may further include a new cartridge receiver that holds a new material cartridge and makes new material available from the new material cartridge as build material for printing.

Moreover, the 3D printer may have a build platform to receive build material to form the 3D object. Furthermore, a first conveying system of the 3D printer may facilitate transport of new material and recycle material as build material to, for example, a build enclosure such as a build chamber, build bucket, and the like. The build enclosure may at least partially contain or otherwise be associated with the build platform on which the 3D printer prints or generates the 3D object. In one example, the first conveying system includes a pneumatic conveyance system. A second conveying system may facilitate recovery of excess build material or powder from the build platform and build enclosure. In an example, the second conveying system includes a vacuum system.

Examples provide for a 3D printer that may receive new material and also handle recycle material. The printer conveying systems may include, for instance, a closed-loop or substantially closed-loop material handling system for transporting material internally within the 3D printer. Certain examples may generally not employ external dedicated resources, extensive floor space separate from the printer, or external equipment to mix powder or extract 3D objects from unfused powder. In addition, examples may facilitate handling of recycle material. In examples, recycle material within a 3D printer may be loaded into cartridges held internally in the printer. The cartridges filled with the recovered material or recycle material may be removed and stored for future use. Thus, some examples may provide for adding and removing material from the 3D printer. For particular examples, recycle material may remain substantially free of external contaminants. Closed-loop material handling may reduce the risk of unknown material entering the 3D printer, and so forth.

In one implementation, a material input to the printer is new material. A material input may also possibly or intermittently include recycle material, though recycle material may be more commonly removed from the printer rather than an input to the printer. Again, the recycled material may be produced as a result of printing operations and is stored internally. However, the amount of recycle material may exceed internal storage capacity and be removed from the printer.

Example techniques for handling of build material by a 3D printer, and the selective solidification of the build material by the 3D printer to form a 3D object, are discussed herein. Manual handling of build material may be reduced. Further, the build material may include new or fresh material, as well as recycle material or reclaim material recovered from the printer. Again, the 3D printer may generally include a build platform on which the 3D printer forms a 3D object from the build material. As mentioned, the 3D printer may also include a build enclosure associated with the build platform. As discussed below, in some examples, the printer may incrementally lower the build platform as each layer of the 3D object is printed or formed.

The material cartridge in the 3D printer cartridge receiver may be operationally removable. The material cartridge may be a housing or canister to contain the material. The material cartridge may be inserted into or operationally positioned in the cartridge receiver. As mentioned, the cartridge receiver that holds or retains the material cartridge may be a cavity, receptacle, slot, sleeve, or any combinations thereof. Again, in examples, the 3D printer may form the 3D object from the material in the material cartridge made available by the cartridge receiver from the material cartridge. The material may be made from one or more of metal, plastic, polymer, glass, ceramic, or other material. The material cartridge in the cartridge receiver may receive material from the 3D printer and make available material to the 3D printer for printing of the 3D object. In some examples, a printer conveying system may transport the material to a build enclosure for printing. If employed, a selective solidification module of the printer may be adjacent to or at least partially above the build enclosure.

The 3D printer may include a build-material applicator, such as a powder spreader or powder spreader arm, to distribute the build material layer-by-layer across the build platform. The build-material applicator may include additional components to facilitate receipt of build material from the conveying system and to discharge or distribute build material (e.g., powder) to the build enclosure and build platform. As discussed below, a movement device in some examples may move the powder spreader or facilitate operation of the powder spreader over the build platform.

The selective solidification module may include an energy source to apply energy, such as heat or light, to the build material to facilitate solidification, e.g., sintering, melting, fusing, etc., of the build material into the 3D object. The selective solidification module may also include one or more movement devices, such as a carriage(s), to hold, move, and/or position the energy source over the build material on the build platform.

If thermal fusion is employed, the selective solidification module may include a thermal fusion system which includes a printbar to eject print liquid onto the build material placed on the build platform. The printbar may have nozzles to eject the print liquid. The printbar may eject the print liquid to specific points or areas of the build material surface under the control of a 3D model to form the 3D object layer-by-layer. In certain examples, the print liquid as a fusing agent may increase absorption of energy by the build material where the print liquid is applied.

In general, the 3D printer may have the selective solidification module to solidify a 3D object from the build material to form the 3D object. Moreover, again, the build material may be made available via the 3D printer having more than one cartridge receiver to hold material cartridges to provide build material. In a 3D printer having two cartridge receivers, one cartridge receiver may receive a first cartridge containing new material. The other cartridge receiver may receive a second cartridge containing recycle material or may receive an empty cartridge to collect recovered build material from the 3D printer. Cartridges containing new material may be inserted into both receivers at least initially or in some cases when recycle material is not to be recovered. The recycle material or recovered material may be excess material from a build enclosure of the printer. The excess material may be material that did not become part of the 3D object or did not fuse into the 3D object during the generation of the 3D object. Recycle material may be referred to as reclaim material, reclaimed material, recycled material, excess material, unfused material, etc.

Recycle material cartridges, whether empty or full, may be removed and stored for future use or discarded. Moreover, once a fresh or new material cartridge has been emptied by the 3D printer, the empty fresh material cartridge may be inserted into the second cartridge receiver as a recycle material cartridge to receive unfused or recycle material. Also, the 3D printer may include multiple internal vessels to store fresh material received from the fresh material cartridge or recycle material received from either the recycle material cartridge or the build enclosure. In one implementation, new material from a new material cartridge, e.g., fresh powder cartridge, is emptied into an internal vessel or hopper, and the fresh or new material used by the printer is taken from this internal vessel as build material for the printer to form the 3D object. However, in another implementation, there is no internal vessel or hopper, and fresh or new material is taken directly from the new material cartridge for the printer to form the 3D object.

Thus, certain examples of a 3D printer may have one or multiple material cartridge receivers, e.g., slots, to receive and secure a material cartridge. As mentioned, the material cartridge may be operationally removable from the material cartridge receiver or slot. A slot with a material cartridge therein may both provide material to the 3D printer and recover material from the 3D printer. In particular examples, the 3D printer may have two slots, one for “new” material and a second for “recycle” material. Other examples may have more than two slots for material cartridges, or a single slot for a material cartridge. The new or fresh material slot may hold a material cartridge that supplies, makes available, or otherwise provides new material as build material for the build enclosure for printing of the 3D object. However, the recycle material slot may hold a material cartridge that receives material from the 3D printer such as from the build enclosure. The material entering the material cartridge in the recycle material slot may be surplus material left over from the printing of the 3D object. The recycle material slot may also hold the material cartridge to make available recycle material as build material for the build enclosure for printing of the 3D object.

When a new material cartridge is substantially or fully depleted, e.g., when the 3D printer has consumed the contents of the material cartridge, the material cartridge may be removed by the user and re-purposed for later use in the recycle material slot. In one example, the empty cartridge as a recycle material cartridge in a slot or in a recycle material slot may receive excess or unsolidified powder from the printer at the conclusion of a print job. The material cartridge in the recycle material slot containing recycle material may then supply or otherwise provide recycle material for printing. Again, as mentioned, examples of 3D printers may have multiple slots for material cartridges.

User removal of the emptied new-material cartridge may generally occur soon or immediately after emptying, so the 3D printer can be replenished with more new material from another new material cartridge to be inserted. However, the re-installation or re-use of the empty and now “recycle” cartridge may not occur for some time. In some examples, the 3D printer may operate without material cartridges installed. The empty cartridge as an empty recycle cartridge may be stored away from the printer until recycle material is to be received by the 3D printer. In other words, the user may retain the empty recycle cartridge in storage external to the printer for future use by the printer. Indeed, the user may store many of the empty recycle cartridges. The 3D printer may request the user to re-install an empty or not completely-full recycle cartridge in a slot such as the recycle material slot. Moreover, multiple material types may be employed by a 3D printer at different times and therefore labels, markings, indicators, or other techniques may facilitate accounting of recycle material types in the recycle cartridges.

The recycle material cartridge and associated slot in the 3D printer in receiving excess material from the build enclosure may, therefore, facilitate offloading of excess material from the printer. In other words, as discussed, a recycle cartridge in the single slot or in the second slot of the 3D printer may receive excess material from the build enclosure after printing. As also mentioned, the excess material may be build material from the build enclosure that did not become solidified into the 3D object.

Full or partially-filled recycle cartridges in a cartridge slot of the printer may supply recycle material for the build enclosure, or be removed for future use. In other words, some of these cartridges filled with recycle material may remain in place in the printer slot, or be removed and stored or discarded. Some of these recycle cartridges filled with recycle material may be removed and kept for future use such as when the 3D printer is short of recycle material that is to be mixed with new material and utilized or consumed during printing. In certain examples of a 3D printer with a single slot for a material cartridge, a new material cartridge may be inserted into the slot and have the contents thereof emptied into an internal storage vessel of the printer. The cartridge could then become a recipient for recycle material.

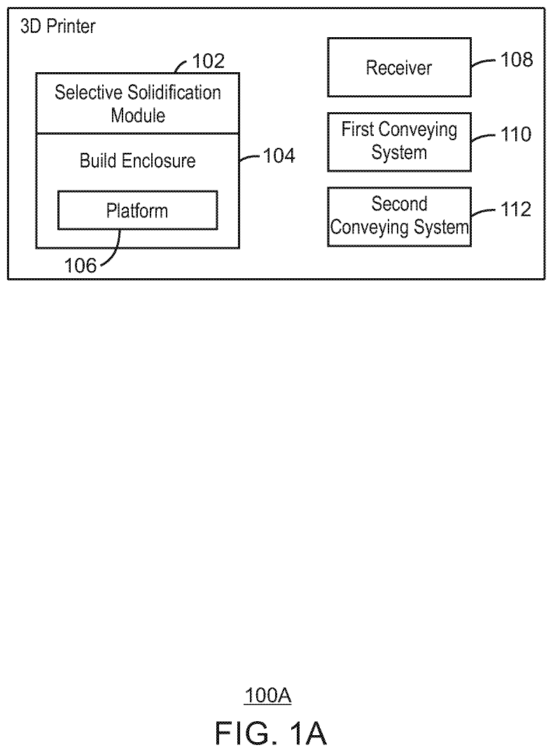

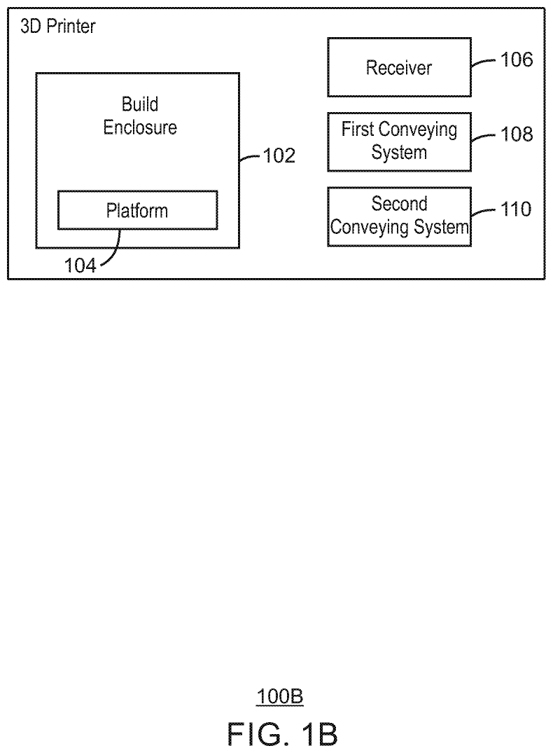

FIG. 1A is a 3D printer 100A having a selective solidification module 102 disposed above a build enclosure 104. The selective solidification module 102 may selectively solidify portions of successive layers of a build material on a build platform 106 to print or form a 3D object. In operation, the 3D printer 100A may place build material, e.g., powder, on the build platform 106 to generate the 3D object. In some examples, the selective solidification module 102 may function at least partially over the build platform 106 to form the 3D object. The build platform 106 may receive build material, for example, as solid particles of powder from a conveying system internal to the printer, and then the selective solidification module 102 solidifies (e.g., sinters, melts, fuses, etc.) the solid particles layer-by-layer into the shape of the 3D object to generate or form the 3D object.

The selective solidification module 102 may include an energy source to apply energy to the build material on the build platform 106 to form the 3D object on the build platform 106. The application of energy may selectively solidify, e.g., sinter, melt, fuse, etc., portions of successive layers of build material on the build platform 106 to generate the 3D object. The energy source may be a light source, heat source, radiation source, laser, heat lamp, electron beam, infrared source, near infrared source, and so on.

Aspects of the discussion of FIG. 1 may be applicable to the printer 100A as a selective laser sintering (SLS) printer, such as with the selective solidification module 102 performing SLS or similar 3D printing technique via applying energy (e.g., a laser) to the build material. In other examples, the printer 100A is not a SLS printer, and the selective solidification module 102 is, for example, a thermal fusion system which performs, via applied energy and print liquid, fusion for selective solidification. Other configurations are applicable.

In some examples, the selective solidification module 102 may include a printbar to eject a print liquid onto the build material on the build platform 106 to facilitate formation of the 3D object, such as with thermal fusion. If so, the 3D printer 100A may apply energy, via the energy source, to the print liquid, e.g., fusing agent, ejected onto selected portions of the build material on the build platform 106 to fuse the selected portions of the build material to form the 3D object layer-by-layer. In certain examples, the energy may be applied to the build material on the build platform relatively uniformly and, therefore, to the print liquid ejected onto the build material. Yet, the print liquid may increase application of the energy to the portions of the build material on which the print liquid resides.

Further, the selective solidification module 102 may include a movement device to position the energy source and/or the printbar (if employed) over the build platform 106. The movement device may be, for example, a carriage or other type of movement device. More than one movement device may be employed.

The 3D printer 100A may have a cartridge receiver 108 to hold a material cartridge. The cartridge receiver 108 may be a cavity, receptacle, slot, sleeve, or any combinations thereof. The material cartridge inserted or installed into the cartridge receiver 108 may have a housing to contain or hold the material. In some examples, the material cartridge may be sealed or substantially sealed to prevent or reduce build material from leaking or escaping to the environment when the material cartridge is removed from the printer. This may facilitate clean and relatively convenient handling of material. The cartridge receiver 108 may accept excess material into the material cartridge from the build enclosure 104 and build platform 106, and make material available from the material cartridge for the build enclosure 104 and build platform 106 for printing of the 3D object. Alternatively, or in addition, material stored in an internal storage vessel may be fed to the build enclosure 104. The printing of the 3D object may involve the formation of the 3D object from the material from the material cartridge. The material as build material may be a powder composed of plastic, polymer, metal, glass, ceramic, or any combinations thereof.

In some examples, the 3D printer 100A may include a conveying system to receive the material made available by the cartridge receiver 108 and the material cartridge. The conveying system may include a feed vessel or dispense vessel to provide the build material to a powder handling system near the build platform 106. The powder handling system may receive the build material from the conveying system and the dispense vessel. The powder handling system may include, for example, a feed apparatus or dosing device and a build-material applicator or powder spreader. In certain examples, the feed apparatus or dosing device may receive the material from the feed vessel and dose the material to the build platform 106 at the build enclosure 104. The dosing device may include a container or box to provide a desired volume or weight of build material to the build platform 106. A build-material applicator, such as a powder spreader, may disperse the dosed build material across the top or upper surface of the build platform 106.

As mentioned, a powder handling system may include the feed apparatus or dosing device and the build-material applicator or powder spreader, and other components. Moreover, in this example, the powder spreader is not a component of the selective solidification module 102. However, in another example, the powder spreader may be considered a component of the selective solidification module 102. In either case, the powder spreader or similar component may distribute build material across the build platform 106.

In summary, the powder handling system, which may be downstream of a feed vessel, may include a feed apparatus (e.g., a dosing device), a powder spreader, and other components. In some examples, the feed apparatus may receive build material from the feed vessel. In other words, the feed apparatus may receive build material from the conveying system through the feed vessel. The feed apparatus may discharge or dose build material for the powder spreader to distribute the dosed build material across the build platform 106. In one example, the feed apparatus discharges a line or ribbon of build material to a surface adjacent to the build platform 106 for the powder spreader to distribute across the build platform 106.

Energy from an energy source of the selective solidification module 102 may selectively sinter, melt, or fuse, or cause selective solidification or fusion of, the material on the build platform 106 to form a layer of the 3D object. The energy may be light or heat. The energy source may be a light source or heat source. The feed dosing apparatus and build-material applicator may disperse more material across the surface of the build platform 106 to form the next layer. This repeated dispersion or distribution of build material onto the build platform 106 and application of energy to the build material on the build platform 106 may continue for successive layers until the 3D object is completely formed or substantially completely formed. As mentioned for some examples, the selective solidification module 102 may include a printbar to eject a print liquid onto the build material on the build platform 106 to facilitate formation of the 3D object. The printbar may eject print liquid onto the build material on the build platform 106 for each layer to form successive layers.

The cartridge receiver 108 may be a recycle cartridge receiver 108. As such, the material cartridge may be a recycle material cartridge. Note, however, the cartridge receiver 108 may not be a dedicated recycle-cartridge receiver in certain examples. In other words, the printer 100A may include conduits or ducting and associated control valve(s) that provide for flexibility of the operating designation of the cartridge receiver 108.

The recycle material cartridge may contain recycle material. Recycle material may be excess or unfused material left over from printing a 3D object. In some examples, the printer 100A may include a build-material reclaim system to separate unfused build material from fused build material after the generation of a 3D object. The recycle material cartridge may provide or make available recycle material for the build enclosure 104 and build platform 106. At the build enclosure 104, the 3D object is thus formed from the recycle material on the build platform 106. Generally, each layer of build material processed on the build platform 106 may be a mix of new build material and recycle build material, although the build material or a layer of build material on the build platform may be 100% new material or 100% recycle material.

In some examples with two cartridge receivers 108, one of the material cartridges may not include build material. For instance, in one example, one cartridge may have build material and the other cartridge may have non-build material such as a flow additive or flow aid, or other compound. The material cartridge with the build material may have new material or recycle material as the build material. Thus, for particular examples at certain times of operation, a recycle material cartridge may not be employed or a new material cartridge may not be employed.

The selective solidification module 102 may be disposed at least partially above the build enclosure 104. Together, the build enclosure 104 and the associated build platform 106 may constitute a build unit. In certain examples, the build unit may be operationally removable. Indeed, while FIG. 1A depicts a build platform 106, the printer 100A may be manufactured and sold without the build platform 106.

The 3D printer 100A may have a first conveying system 110 to transport material from the cartridge receiver 108 (and material cartridge) and from any associated material vessel. The first conveying system 110 may transport the material through a feed vessel or dispense vessel to a feed powder handling system including, for instance, a dosing device and a build-material applicator or powder spreader. Thus, the first conveying system 110 may facilitate delivery of build material to the build-material applicator for the build platform 106. The first conveying system 110 may be integrated partially, substantially fully, or fully within the 3D printer 100A. The first conveying system 110 may include the aforementioned feed vessel or dispense vessel and provide material through any dosing or feed apparatus to the build-material applicator, build platform 106, and build enclosure 104. The 3D printer 100A may have a second conveying system 112, which may also be integrated within the printer 100A. In some examples, as discussed below, the second conveying system 112 may be involved in recovery of build material from the build enclosure 104. The conveying systems 110 and 112 may each include a motive component to provide a motive force on conveying fluid to transport build material. The conveying fluid may generally be a conveying gas. In one example, the motive component may be a venturi or a blower, or both, and the conveying fluid may be air.

The conveying systems 110 and 112 may each include a separator, e.g., a cyclone, filter, etc., to separate the conveying fluid from the build material and discharge the conveying fluid to the motive component. As described below with respect to subsequent figures, the dispense vessel of the first conveying system 110 may receive the build material from the separator and provide the build material to a dosing feed apparatus and a build-material applicator (e.g., powder spreader) to apply the build material across the build platform 106. The second conveying system 112 of the 3D printer 100A may include conduits or a manifold to receive excess build material from the build enclosure 104 and transport the recovered material to, for example, a reclaim vessel. Indeed, a reclaim vessel may receive the excess build material from the second conveying system 112, as also discussed below.

FIG. 1B is a 3D printer 100B similar to the 3D printer 100A of FIG. 1A. The 3D printer 100B may have a build enclosure 102 associated with a build platform 104. Successive layers of a build material may be applied and selectively solidified on the build platform 104 to print or form a 3D object. The 3D printer 100B may also include a cartridge receiver 106 to hold a material cartridge. The cartridge receiver 106 may accept excess build material into the material cartridge from the build enclosure 102 and build platform 104, and make build material available from the material cartridge for the build enclosure 102 and build platform 104 for printing of the 3D object.

A first conveying system 108 may transport build material through a feed apparatus to a build-material applicator above the build enclosure 102. The build-material applicator may disperse build material across a surface of the build platform 104 at the build enclosure 102. An energy source may apply energy to the build material on the build platform 104. For example, a laser source may apply a laser to specific selected points on the build material to sinter those points of the build material. In another example, a printbar may apply print liquid, such as a fusing agent, to specific selected points, and the energy applied facilitates fusing of the build material at those points. In general, the energy from the energy source may solidify those portions of the build material to form a layer of the 3D object. Successive layers may be formed in the same way, e.g., by dispersing build material across a surface of the build platform 104 and applying energy from an energy source. When formation of the 3D object is complete or substantially complete, the second conveying system 110 may recover excess or unfused build material from the build enclosure 102. In some examples, the second conveying system 110 may recover excess or unfused build material during printing of the 3D object.

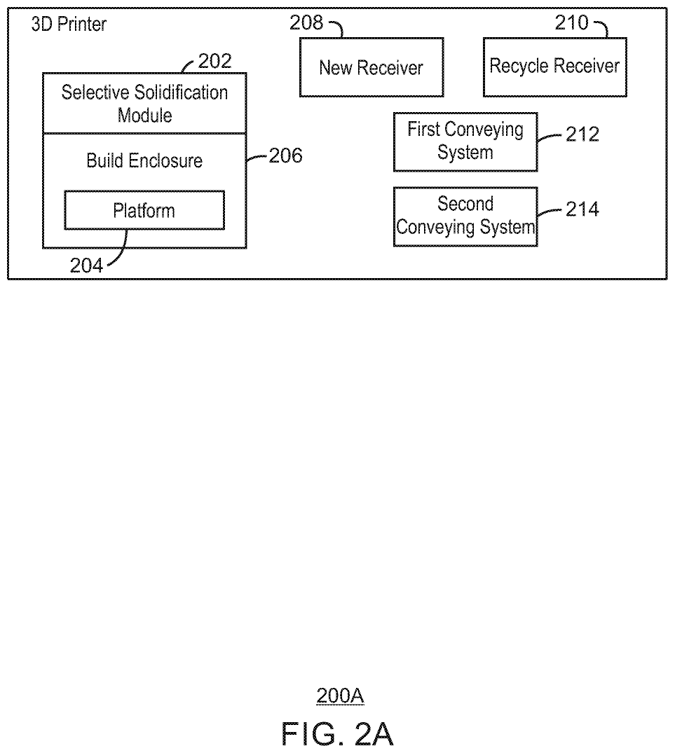

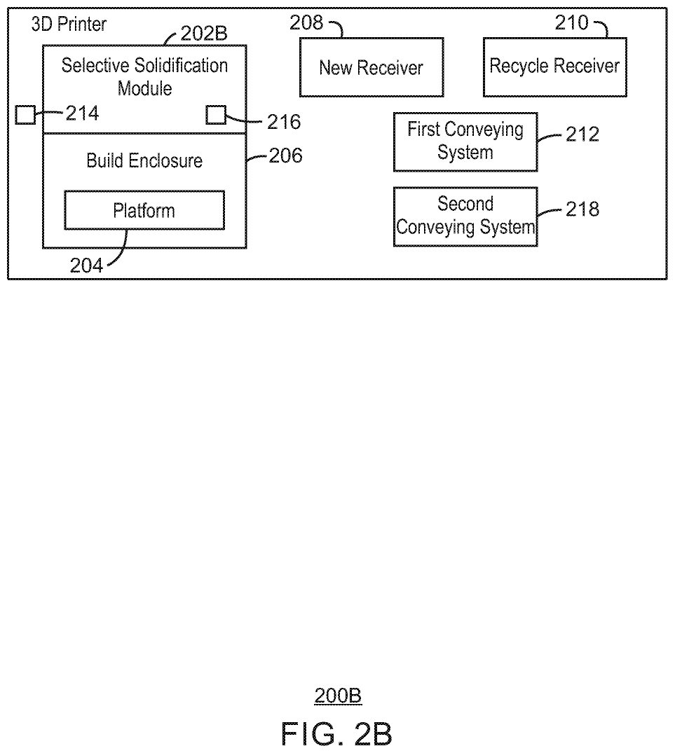

FIG. 2A is a 3D printer 200A having a selective solidification module 202 to selectively solidify portions of successive layers of build material on a build platform 204 associated with a build enclosure 206. The selective solidification module 202 may include an energy source, movement device(s), and other components. A powder spreader may disperse the build material across a surface of the build platform 204. The energy source may apply energy to the build material on the build platform 204. Energy from the energy source may selectively sinter or fuse portions of successive layers of build material on the build platform 204. For example, the energy source may be a laser, light source, radiation source, or heat source. A movement device may locate the energy source over the build platform 204. The movement device may be a carriage. In some examples, the selective solidification module 202 may include a printbar to eject a fusing agent onto the build material on the build platform 204. The printbar may be moved, located, or positioned over the build platform 204 by another movement device or by the same movement device that locates the energy source over the build platform 204.

The 3D printer 200A may include a new cartridge receiver 208 to hold a new material cartridge. The new cartridge receiver 208 and the new material cartridge may make new material available for the build enclosure 206 and build platform 204 for printing of a 3D object. For example, the new cartridge receiver 208 and/or a new material vessel may discharge new material to a first conveying system 212, such as through a feeder to a conduit of the first conveying system 212. The first conveying system 212 may transport the new material to a feed vessel or dispense vessel. The printer 200A may also include a recycle cartridge receiver 210 to hold a recycle material cartridge. The recycle cartridge receiver 210 and the recycle material cartridge may make recycle material available for the build enclosure 206 or build platform 204 for printing of the 3D object. For example, the recycle cartridge receiver 210 and/or a recycle material vessel may discharge recycle material through a feeder to a conduit of the first conveying system 212. The first conveying system 212 may transport the recycle material to the feed vessel.

The first conveying system 212 of the 3D printer 200A may transport new material and recycle material to the build enclosure 206 at a specified ratio of new material to recycle material. The ratio may range from zero, e.g., no new material, all recycle material, to 1.0, e.g., all new material, no recycle material. The ratio may be a weight ratio, volume ratio, or other type of ratio. The ratio as a weight ratio or volume ratio may range from 0.01 to 0.99, 0.05 to 0.95, 0.1 to 0.9, 0.15 to 0.85, 0.2 to 0.8, 0.25 to 0.75, 0.3 to 0.7, etc. In a particular example, the feed to the build enclosure 206 may be 20% new material by weight and 80% recycle material by weight, yielding a weight ratio of 0.25. In another example, the feed has 20% new material by volume and 80% recycle material by volume, yielding a volume ratio of 0.25.

A second conveying system 214 may apply a vacuum to the build enclosure 206 to remove excess build material from the build enclosure 206. As mentioned, excess build material may be build material that is not incorporated into the 3D object formed. As discussed, the excess build material may be recovered into a recycle material cartridge or recycle material vessel. The excess build material may be combined with new material and other recycle material to feed the build enclosure 206 and the build platform 204.

FIG. 2B is a 3D printer 200B similar to the 3D printer 200A of FIG. 2A. The 3D printer 200B may include a selective solidification module 202B to solidify portions of layers of build material on a build platform 204 associated with a build enclosure 206 to form a 3D object. The 3D printer 200B may also include a new cartridge receiver 208 to receive a new material cartridge and a recycle cartridge receiver 210 to receive a recycle material cartridge. As discussed, the 3D printer 200B may feed both new material and recycle material as build material to the build platform 204. A build-material applicator 214, e.g., a powder spreader or powder spreader arm, may disperse the build material across a surface of the build platform 204. In some examples, the build-material applicator 214 may be disposed on a movement device such as a carriage. The build-material applicator 214 may have a roller or mechanical arm to spread or disperse build material. A first conveying system 212 may transport build material to the build-material applicator 214, such as through a dosing feed device or apparatus.

The selective solidification module 202B may include an energy source(s) 216. The energy source(s) 216 may be carried by or associated with a movement device, such as a carriage, that locates or positions the energy source 216 above the build platform 204. In some examples, the energy source 216 may be static and not operationally movable. The energy from the energy source 216 may selectively solidify, e.g., sinter or fuse, the build material on the build platform 204 to form a 3D object. In some examples, the selective solidification module 202B may include a printbar (not shown) that may move across the build platform 204 and eject a print liquid onto the build material on the build platform 204. If employed, the printbar may be disposed on a movement device, e.g., a carriage, which positions the printbar above the build platform 204. The printbar may eject print liquid via multiple nozzles of the printbar. In some examples, the energy source(s) 216, such as a light source or heat source, may move across the build platform 204 and apply energy substantially uniformly to the build material and, thus, apply energy to the print liquid ejected onto the build material on the build platform 204. The energy from the energy source(s) 216 may selectively fuse the build material contacted by the print liquid. Indeed, the presence of the print liquid may accelerate and increase absorption of energy into those selected portions of build material where the print liquid is ejected and applied. A second conveying system 218 may remove excess build material from the build enclosure 206.

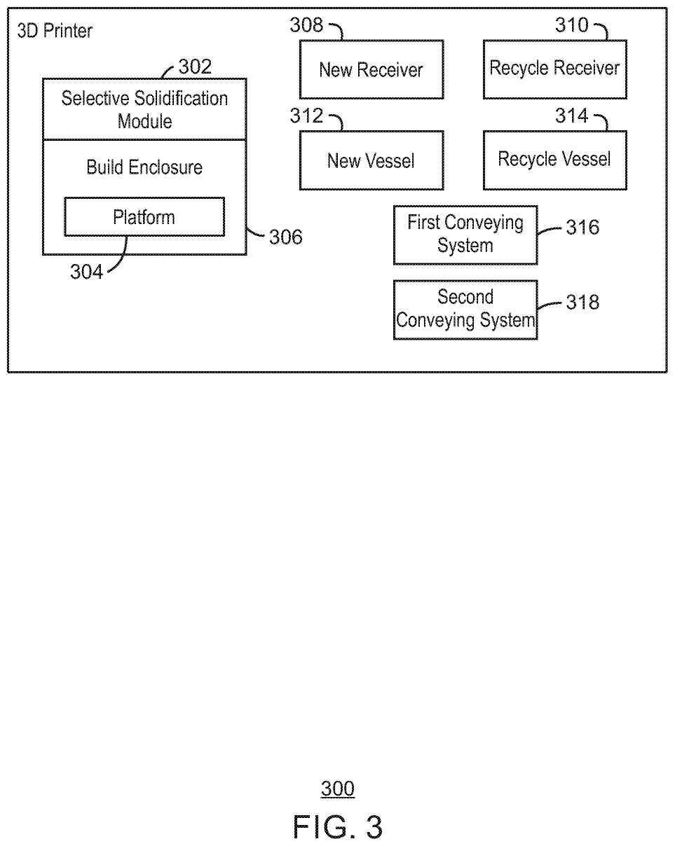

FIG. 3 is a 3D printer 300 having a selective solidification module 302 to solidify, sinter, melt, or fuse build material on a build platform 304 to form a 3D object. The printer 300 and its selective solidification module 302 may selectively solidify portions of successive layers of the build material on the build platform 304. In certain examples, the 3D printer 300 may include a build-material applicator to spread the build material on the build platform 304, a movement device to move the build-material applicator over the build platform 304, and an energy source to apply energy to the build material on the build platform 304. The application of energy from the energy source may selectively solidify portions of successive layers of build material on the build platform 304. The same movement device that positions the build-material applicator or another movement device may carry the energy source over the build enclosure 306 and build platform 304. In some examples, an energy source may be static and not moved during printing. The selective solidification module 302 may also include a printbar to eject a print liquid, e.g., a fusing agent or detailing agent, onto the build material on the build platform 304 before or contemporaneous with application of energy from the energy source.

In the illustrated example, the 3D printer 300 may include a new cartridge receiver 308 to hold a new material cartridge and a recycle cartridge receiver 310 to hold a recycle material cartridge. The printer 300 may include a new material vessel 312 disposed internal to the printer 300 and near the new cartridge receiver 308 to receive new material from the new material cartridge in the new cartridge receiver 308. Likewise, a recycle material vessel 314 may be disposed internal to the printer 300 and near the recycle cartridge receiver 310 and may receive recycle material from the recycle material cartridge in the recycle cartridge receiver 310. The new material and recycle material may be gravity fed or otherwise conveyed to the new material vessel 312 and the recycle material vessel 314, respectively. In particular examples, the vessels 312 and 314 may be removed from the 3D printer 300 and emptied. Alternatively, the vessels 312 and 314 may be emptied by the 3D printer 300 feeding the build enclosure 306 and build platform 304 from the vessels 312 and 314. If the vessels 312 and 314 are filled with material, the 3D printer may operate without the insertion of material cartridges. Moreover, in certain examples, the material cartridges may be rotated within the 3D printer 300 to de-aggregate material that has been stored for extended periods of time in the 3D printer 300.

A first conveying system 316 of the 3D printer 300 may transport new material from new material vessel 312 and recycle material from recycle vessel 314 to a feed vessel or dispense vessel. The first conveying system 316 may include the feed vessel or dispense vessel. The dispense vessel may supply a mix of new material and recycle material as build material through a feed apparatus or dosing device to the build platform 304. A build-material applicator, such as a powder spreader, may distribute the build material across the build platform 304.

A second conveying system 318 of the 3D printer 300 may remove excess build material from the build enclosure 306 after the printing of a 3D object. In other words, for example, this is performed after generation of the 3D object is complete. In one example, this withdrawal of excess material from the build enclosure 306 is performed after completion of the generation of the 3D object or after completion of the print job. In another example, the withdrawal of excess build material may be performed both during the print job and after completion of the print job.

A reclaim vessel may collect the excess build material from the build enclosure 306 and the second conveying system 318. In examples where there is a reclaim vessel, the excess build material as recovered material may be withdrawn from the reclaim vessel and combined as feed with new material from new material vessel 312 and recycle material from recycle material vessel 314. The combination of recovered or reclaim material, new material, and recycle material may be transported by the first conveying system 316 to the dispense vessel. Moreover, the excess build material may be recovered from the build enclosure 306 via the first conveying system 316, bypassing any reclaim vessel associated with the second conveying system 318. The first conveying system 316 may transport the recovered material to the recycle material vessel 314, the recycle cartridge, or the build-material applicator, in some examples.

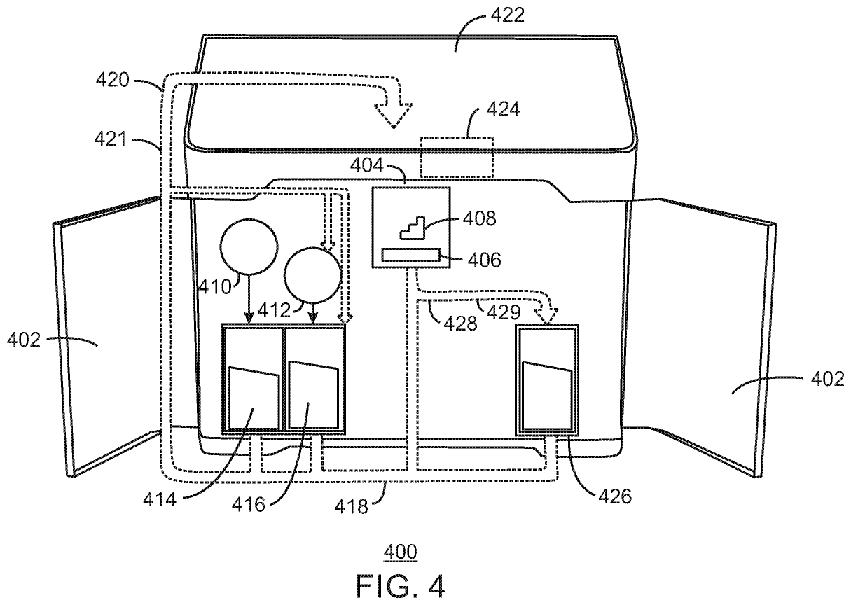

FIG. 4 is a 3D printer 400 shown with its front access panels 402 open and an interior portion of the 3D printer 400 visible. The 3D printer 400 may include a build enclosure 404. The build enclosure 404 may be associated with a build platform 406 on which a 3D object 408 is formed from feed material composed of a mix, as described above, of new material and recycle material. The 3D printer 400 may include a new cartridge receiver 410 that receives and holds a new material cartridge to make new material available from the new material cartridge to the 3D printer 400. The 3D printer 400 may include a recycle cartridge receiver 412 to receive and hold a recycle material cartridge to accept excess material from the build enclosure 404. In addition, the recycle cartridge receiver 412 may make recycle material available from the recycle material cartridge to the 3D printer 400. Moreover, the printer 400 may determine when an internal recycle vessel or hopper is full and instruct a user to insert an empty material cartridge which can then be filled with recycle material from the full internal recycle vessel.

In particular examples, the new cartridge receiver 410 or other component may rotate the new material cartridge to prevent, reduce, break up, or dislodge agglomeration of the powdered new material in the new material cartridge. Likewise, the recycle material cartridge may rotate in the recycle cartridge receiver 412 to prevent or reduce agglomeration of the powdered recycle material in the recycle material cartridge. If such rotation is employed, the new material cartridge and the recycle material cartridge may be filled or emptied while the cartridges are rotating in one example. In one example, the printer 400 and the cartridge receivers 410 and 412 do not provide for rotation of the material cartridges to reduce agglomeration.

The 3D printer 400 may include a new material vessel 414 to receive new material from the new material cartridge in the new cartridge receiver 410. The printer 400 may include a recycle material vessel 416 to receive recycle material from the recycle material cartridge in the recycle cartridge receiver 412. The new material from the new material vessel 414 and the recycle material from the recycle material vessel 416 may be provided to a first conveying system 421. The new material and the recycle material may intermingle or mix in-line as the material moves through the first conveying system 421. In one example, a mixing device such as a baffle or static mixer is employed in-line in the conveying conduit. In another example, the first conveying system 421 is a pneumatic conveyance system in which the material is conveyed at a relatively high velocity which may promote mixing. The mix of new material and recycle material 420 may be supplied via the first conveying system 421 to the build platform 406.

In FIG. 4, a dashed box is a representation of the selective solidification module 424 which may include several components, including components that operationally move over the build enclosure 404 and build platform 406. The selective solidification module 424 generally may include an energy source to apply energy to the build material on the build platform 406. Energy from the energy source may be applied to the build material to form a layer (or layers) of the 3D object 408. The movement and positioning of the energy source over the build platform 406, and the application of energy in certain examples, may be per a 3D model under computer control. The selective solidification module 424 may also include a printbar to eject print liquid onto the build material on the build platform 406. In some examples, the printbar may have nozzles to eject the print liquid. Moreover, the print liquid may be ejected at particular points, lines, or regions on the build material to fuse those portions of the build material in forming each layer of the printed 3D object 408. The movement and positioning of the printbar over the build platform 406, and the ejecting of the print liquid, may be according to a 3D model under computer control.

In the example shown in FIG. 4, the 3D printer 400 has doors or access panels 402 and a top surface 422. Indeed, the printer 400 may generally have a partial or overall enclosure to house printer 400 components. Some printer 400 components may be readily removable or operationally removable, whereas other printer 400 components may be more static or intended to not be regularly removed. Lastly, the conduits indicated, for example, by reference numbers 418 and 420 are representations of general flow of material or powder via the first conveying system 421. The printer 400 conduits (e.g., piping, tubing, etc.), fittings, and valves associated with such flow of material and the first conveying system 421 may be housed inside the printer 400 in some examples.

Excess build material, e.g., unsolidified material, may be recovered from the build enclosure 404. For example, a second conveying system 429 may recover and convey the excess build material 428 from a bottom portion (or other portions) of the build enclosure 404 to the reclaim vessel 426. In some examples, the second conveying system 429 applies a vacuum to the build enclosure 404 to recover the excess build material 428. In certain examples, the excess material 428 may be subjected to filtering, separation, or other processing as part of the second conveying system 429 and/or as associated with the reclaim vessel 426 to remove larger particles, air, and so forth, prior to the excess material entering the reclaim vessel 426.

The first conveying system 421 may transport the recovered material from a discharge on a bottom portion of the reclaim vessel 426 as recycle or reclaim material 418 to the recycle material cartridge in the recycle cartridge receiver 412 or to the recycle material vessel 416. In some examples, the reclaim vessel 426 may be labeled as a second recycle vessel. In addition, or if there is no reclaim vessel 426, excess material 428 recovered from the build enclosure 404 may proceed directly to the first conveying system 421, such as to a conduit(s) of the first conveying system 421 transporting the reclaim material 418.

A build unit processing module may include or involve a build unit including the build enclosure 404 and the build platform 406. The build platform 406 may have holes to allow unsolidified powder to flow through the build platform 406. In addition, the build unit processing module may include sieves, vibration sources such as a motor with an eccentric or off-center mass, air flow devices, and other components to remove excess build material, e.g., unsolidified powder, from the build platform 406. The 3D object 408 disposed on the build platform 406 may cool at an accelerated rate depending on when the excess material or powder not incorporated into the 3D object 408 is removed from the build enclosure 404. In other words, the 3D object 408 may cool faster with surrounding excess build material removed early during the cooling stage. In this fashion, the build unit processing module may manage the cooling process, e.g., by removing the excess build material. The build unit processing module may provide for discharge of excess material 428 from the build enclosure 404.

After most or all of the excess or unsolidified material or powder is removed from the build enclosure 404, the build enclosure 404 may include a 3D object 408 with partially-solidified powder caked on the outside of the 3D object 408. In certain examples, this partially-solidified powder may be removed by a bead blaster, a brush, or other tools that may be part of the build unit processing module. Partially-solidified powder may be removed from the build enclosure 404. Partially-solidified powder may be removed from the 3D object in the build enclosure 404 or after the 3D object has been removed from the build enclosure 404.

Furthermore, in some examples, the printer 400 may have a 3D-printed-object recovery zone. Indeed, once some or most of the unsolidified powder has been removed from the 3D object 408 (and from the build enclosure 404), the 3D object 408 may be recovered via the 3D-printed-object recovery zone in those examples. In operation, the build platform 406 may be manually or automatically lifted (e.g., via an underlying piston) to, or towards, the top of the build enclosure 404 to the recovery zone so that a user may recover the 3D object 408. In an example, this 3D-printed-object recovery zone may be accessed by a user or machine through a top or side opening of the 3D printer 400. The opening may be through an outer housing or casing of the 3D printer 400. In some examples, the zone may be accessed by lifting a lid or a removable top of the 3D printer 400. In other examples, a door(s) of the 3D printer may be opened to access the zone. The recovery zone may include tools to remove any remaining free build material or powder from the 3D object 408 and to clean the build platform 406. The 3D-printed-object recovery zone may also include containers to store printed 3D objects, a light source to illuminate the zone, and devices to provide air flow to prevent or reduce excess build material from exiting the 3D printer 400 during recovery of the printed 3D object, and so on.

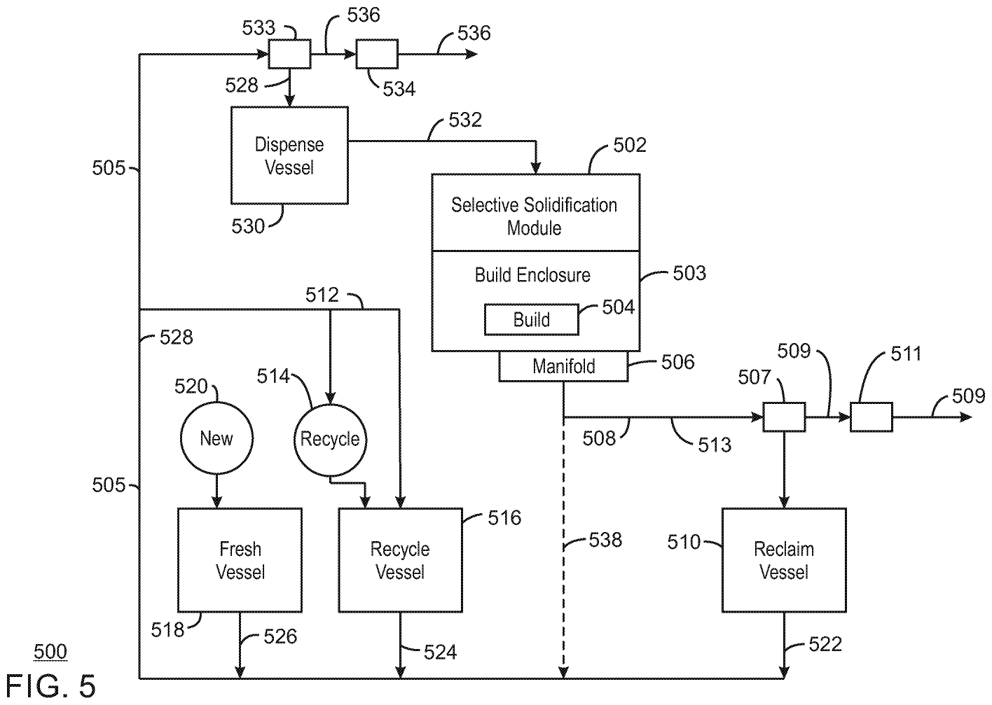

FIG. 5 is a 3D printer 500 having a selective solidification module 502 and a build platform 504. A build enclosure 503 may be associated with the build platform 504. In some examples, the build enclosure 503 at least partially contains the build platform 504. Feed material or build material, e.g., feed powder, may be provided to the build enclosure 503, such as via a first conveying system 505.

A second conveying system 513 may include a manifold 506 and a motive component 511 to withdraw excess material or excess powder, e.g., powder not incorporated into a 3D object, from the build enclosure 503 as recovered material 508. In examples, this is performed after generation of the 3D object is complete. In one example, this withdrawal of excess material from the build enclosure 508 is performed after completion of the generation of the 3D object or after completion of the print job. In another example, the withdrawal of excess build material is performed both during the print job and after completion of the print job.

The manifold 506 may be coupled to build enclosure 503. The motive component 511 may include a vacuum pump, a blower, a venturi, an eductor, a steam jet, or any combinations thereof. The recovered material 508 may be conveyed via the second conveying system 513 including the manifold 506 and motive component 511 to a reclaim vessel 510. The recovered material 508 and conveying fluid 509, e.g., air, may flow through a separation system 507. The separation system 507 may include a cyclone, filter, etc. to separate conveying fluid 509 from the recovered material 508. The conveying fluid 509 may discharge through the motive component 511, such as to the environment or to other equipment for additional processing. The separation system 507 or the reclaim vessel 510 may include sieves, screens, filters, etc. to separate larger particles, e.g., agglomerated or partially-fused particles, from the recovered material 508. The treated recovered material 508 may discharge as recycle or reclaim material 522 from the reclaim vessel 510.

In certain instances, the recovered material 508 may bypass the reclaim vessel 510, as indicated by reference number 538. The first conveying system 505 may transport the recovered material 508 (if bypassing the reclaim vessel 510) to the dispense vessel 530 for the build platform 504, or as indicated by reference number 512, to a recycle material cartridge in the recycle cartridge receiver 514 or to a recycle material vessel 516.

The recycle material vessel 516 may also be provisioned by the recycle material cartridge in the recycle cartridge receiver 514. A new material vessel 518 may be supplied by a new material cartridge in the new cartridge receiver 520. In some examples, the recycle cartridge receiver 514 and the new cartridge receiver 520 may be disposed closer to the bottom of the printer 500 than to the top of the printer 500.

Moreover, the reclaim material 522, and any recovered material 508 bypassing the reclaim vessel 510, may be combined with recycle material 524 and fresh or new material 526. The recycle material vessel 516 and the new material vessel 518 may provide the recycle material 524 and new material 526, respectively. In some examples, the recycle material 524 and the new material 526 may have a desired or specified ratio, e.g., weight ratio or volume ratio, of new material 526 to recycle material 524. The recovered material 508 or reclaim material 522 may have the desired or specified ratio of new material 526 to recycle material 524, or may be classified as recycle material.

As mentioned for certain instances of operation, the first conveying system 505 may provide the reclaim material 522 as recycle material to the recycle material vessel 516, or to the recycle cartridge receiver 514 holding a recycle material cartridge. In such operations, the first conveying system 505 may convey the reclaim material 522 without incorporation or mixing of new material 526 and recycle material 524 with the reclaim material 522.

The feed material 528 fed via the first conveying system 505 to and through a dispense vessel 530 to the build platform 504 may include recycle material 524, new material 526, reclaim material 522, or recovered material 508, or any combinations thereof. In certain examples, the various materials 524, 526, 522, and/or 508 may mix in-line as the feed 528 is conveyed to the dispense vessel 530 by the first conveying system 505. The first conveying system 505 may include the dispense vessel 530.

Thus for some examples, the feed 528 may include reclaim material 522 from the reclaim material vessel 510, recycle material 524 from the recycle material vessel 516, and new material 526 from the new material vessel 518. In operations without reclaim material 522, the new material 526 and recycle material 524 may form the feed material 528 as the material is transported to the dispense vessel 530. The first conveying system 505 including the dispense vessel 530 may provide the feed material 528 as build material 532 for the build platform 504. A control system may facilitate the feed material 528 composition and build material 532 composition having a specified ratio of new material 526 to recycle material 524. The control system may provide for the specified ratio by directing the metering of the weight or volume of material dispensed from the new material vessel 518 and recycle material vessel 516. In summary, the reclaim material 522, recycle material 524, and new material 526 may be fed, via the first conveying system 505, as feed material 528 through the dispense vessel 530 for the build enclosure 503.

In some examples, the first conveying system 505 is a pneumatic conveying system, such as in dilute phase. If so, the first conveying system 505 may include a vacuum component 534 which may be a blower (e.g., air blower), venturi, steam jet, or eductor, or any combinations thereof. If a blower is employed, the blower may be a fan, centrifugal fan, positive displacement blower, or other type of blower. Moreover, in one example, a blower may be positioned elsewhere in the system to provide for a positive pressure system. If a venturi is employed, one example may utilize a motive fluid such as compressed air to generate a venturi action that pulls relatively large volumes of conveying fluid or air through the venturi.

In the illustrated example, the pneumatic conveying air 536 may discharge through the vacuum component(s) 534. The feed material 532 minus most or all of the conveying air 536 may flow, e.g., by gravity, air flow, etc., from the dispense vessel 530 to the build enclosure 503 or other printer 500 components for printing of a 3D object on the build platform 504. In one example, the feed build material 532 flows out of the dispense vessel 530 to a dosing apparatus and/or build-material applicator, which distribute or spread the feed build material on the build platform 504 at the build enclosure 503. In a particular example, the build-material applicator includes a power spreader.

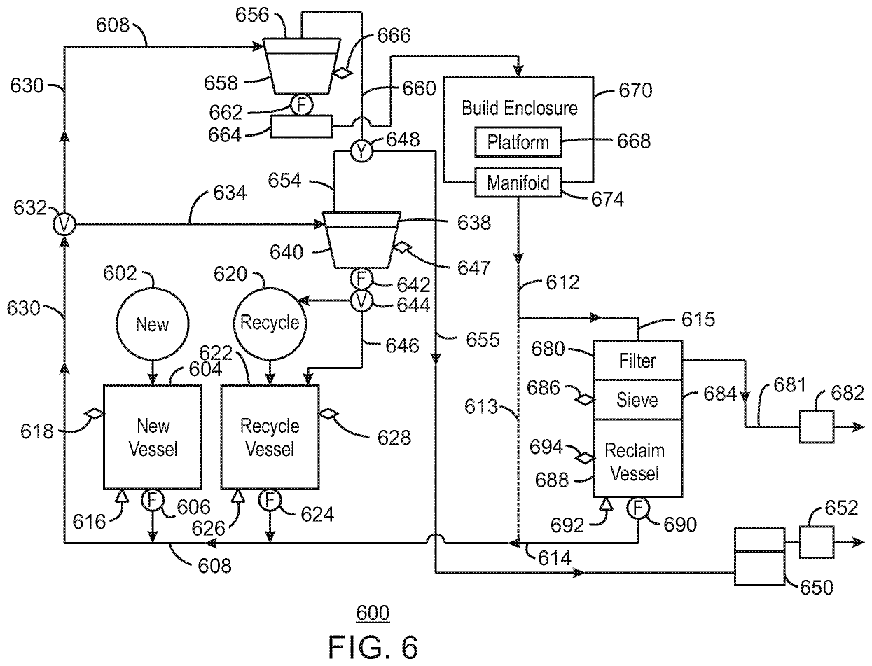

FIG. 6 is a 3D printer 600 having a new cartridge receiver 602 to hold a removable new material cartridge. The new cartridge receiver 602 may make available new material from the new material cartridge as build material. A new material vessel 604 may receive new material from the new material cartridge held by the new cartridge receiver 602. A feeder 606, such as a rotary feeder or auger feeder, may receive new material from the new material vessel 604 and discharge the new material to a first conveying system 608, such as into a conduit of the first conveying system 608. Conveying fluid, e.g., gas or air, may flow through the first conveying system 608.

An air intake such as a filtered manifold or a “lung” may receive, pull in, and/or filter air (e.g., ambient air) as conveying fluid for the first conveying system 608, and also for the second conveying system 615 discussed below. In certain examples, the air intake may also provide air for cooling and cleaning of components in the printer 600, such as a carriage drive system (e.g., encoders, drive motors, and drive belts), printbar(s), an energy source such as heat lamp(s), build enclosure 670, dispense vessel 658, electronics chamber, thermal sensor optics, and so on. Thus, the air as intake via the lung may be employed for both build material conveyance and for cooling or cleaning of printer 600 components.

The new material vessel 604 may have a weight sensor 616. For example, the new material vessel may be disposed on a load cell as the weight sensor 616. Alternatively, or in addition to the weight sensor 616, a level sensor 618 such as a radiation sensor or other type of level sensor may be associated or utilized with the new material vessel 604. The level sensor 618 may measure and indicate the level or height of material in the new material vessel 604. The feeder 606 may facilitate dispensing of the desired amount of new material from the new material vessel 604 into the first conveying system 608. In some examples, the weight sensor 616 and/or the level sensor 618 may also facilitate dispensing of the desired amount of new material from the new material vessel 604 into the first conveying system 608.

The 3D printer 600 may include a recycle cartridge receiver 620 to hold a removable recycle material cartridge. The recycle material cartridge, when installed or inserted into the receiver 620, may receive excess build material as recycle material and make recycle material available as build material. A recycle material vessel 622 may receive recycle material from the recycle material cartridge held by the recycle material receiver 620. In the illustrated example, a feeder 624 receives recycle material from the recycle material vessel 622 and discharges the recycle material to the first conveying system 608. In some examples, the feeder 624 may be a rotary valve feeder, a screw auger, or other type of feeder.

Like the new material vessel 604, the recycle material vessel 622 may have or be disposed on a weight sensor 626. Alternatively, or in addition to the weight sensor 626, a level sensor 628 may be associated with the recycle material vessel 622. As with the new material vessel 604, the corresponding feeder 624 may facilitate dispensing of the appropriate or desired amount of recycle material from the recycle material vessel 622 into a conduit of the first conveying system 608. In certain examples, the weight sensor 626 and/or the level sensor 628 may also facilitate dispensing of the desired amount of recycle material from the recycle material vessel 622 into the conduit of the first conveying system 608.

The first conveying system 608 may transport the build material 630, e.g., a mix of new material and recycle material from the vessels 604 and 622, respectively. In some instances, the build material 630 may also include recovered material 612 or reclaim material 614. In the illustrated example, the first conveying system 608 may convey the build material 630 through a diverter valve 632 to a separator 656 associated with a dispense vessel 658. The dispense vessel 658 may be a feed hopper. The separator 656 may include a cyclone, filter, and so forth. The separator 656 may separate conveying fluid 660, e.g., air, from the build material 630. The build material 630 minus most or all of the conveying fluid 660 may flow into the dispense vessel 658. A feeder 662 may receive build material from the feed or dispense vessel 658 and discharge the build material to a component(s) 664. The component(s) 664 may be a feed apparatus, dosing device, build-material applicator, or powder spreader, and the like, to apply the build material to the build platform 668 at the build enclosure 670. A level sensor 666 may measure and indicate the level or height of build material in the dispense vessel 658.

The first conveying system 608, as indicated by reference number 634, may divert build material 630 via a diverter valve 632 to a separator 638, e.g., cyclone, filter, etc., associated with an alternate vessel 640 or hopper. The separator 638 may remove conveying fluid 654 from the build material 630. The build material 630 minus most or all of the conveying fluid 654 may discharge from the separator 638 into the alternate vessel 640. The build material 630 collected in the alternate vessel 640 is labeled as material 646 which may discharge from the alternate vessel 640 to the recycle material vessel 622 or to the recycle material cartridge in the recycle cartridge receiver 620.

In the illustrated example, the conveying fluid 654 from the separator 638 may flow to a “Y” fitting 648, where the conveying fluid 654 is combined with the conveying fluid 660 from the separator 656. The combination 655 of the conveying fluid 654 and 660 may be pulled from the “Y” fitting 648 through filter 650 by a motive component 652 and discharged to the environment or to additional equipment for further processing. A “Y” fitting 648 may be a conduit fitting having two inlets and one outlet. In the illustrated example, the motive component 652 is a motive component for the first conveying system 608 and applies motive force for the conveying fluid (e.g., air) to transport build material.

This diversion of build material 630, as indicated by reference number 634, may occur, for instance, when the build material 630 is primarily recycle material, reclaim material 614, or recovered material 612. An intent of the diversion may be to add material 646 to the recycle material vessel 622 or recycle material cartridge in the recycle cartridge receiver 620. Indeed, the alternate vessel 640 may discharge material 646 to the recycle material vessel 622 or recycle material cartridge in the recycle cartridge receiver 620 via a feeder 642 and a diverter valve 644. In some examples, the diverter valve 644 may be positioned to direct flow to either the recycle material vessel 622 or the recycle cartridge receiver 620. Moreover, a level sensor 647 may be associated with the alternate vessel 640.

As indicated, in operation of the first conveying system 608, the conveying fluid 660 and 654 may be pulled to the filter 650 and the motive component 652 of the first conveying system 608. The motive component 652 may be an air blower, eductor, ejector, vacuum pump, or other motive component. Because the first conveying system 608 is generally a pneumatic conveying system, the motive component may typically include a blower.

After the 3D object is complete or substantially complete on the build platform 668, excess build material may be removed as recovered material 612 from the build enclosure 670 via the second conveying system 615. Alternatively, the build material may not be recovered. For example, the excess build material may be off-loaded with the 3D object. The excess build material may be removed from the 3D object by a stand-alone vacuum. Or, the 3D object and the excess build material may be ejected into a box separate from the 3D printer. There may be several reasons for off-loading the excess build material with the 3D object. For example, there may be material considerations in that the completed 3D object may not contain recovered or recycle build material. As another example, the 3D printer may be in a fault condition and the excess build material may have to be removed from the 3D printer before restarting the printer. Lastly, in some examples, excess build material may be removed during the printing of the 3D object as recovered material 612 from the build enclosure 670 via the second conveying system 615.

The second conveying system 615 may include a manifold 674 disposed at the bottom and/or other portions of the build enclosure 670 to collect excess build material. In certain examples, the second conveying system 615 may apply a vacuum via the manifold 674 to the build enclosure 670 to pull excess build material from the build enclosure 670. The second conveying system 615 may convey the recovered material 612 through a cyclone or filter 680 to separate the recovered material 612 from the conveying fluid 681, e.g., conveying air, which is discharged through a motive component 682 of the second conveying system 615. The motive component 682 may be an air blower, eductor, ejector, vacuum pump, or other type of motive component.

The recovered material 612 may discharge from the filter 680 and enter a sieve 684 where larger particles of build material or solidified build material not incorporated into the 3D object may be removed. The sieve 684 may have a level sensor 686 which monitors the level or height of solid material in the sieve 684. The recovered build material 612 minus the larger particles may enter a reclaim vessel 688 where the recovered material 612 may be labeled as reclaim material 614. A feeder 690 may dispense the reclaim material 614 into a conduit of the first conveying system 608.

The reclaim vessel 688 may be disposed on a weight sensor 692. Alternatively, or in addition to the weight sensor 692, a level sensor 694 may be associated with the reclaim vessel 688. The weight sensor 692 and/or the level sensor 694, as well as the feeder 690, e.g., rotary feeder, may facilitate dispensing of the appropriate or desired amount of reclaim material 614 from the reclaim vessel 688.

As mentioned, the first conveying system 608 may transport the reclaim material 614 along with new material and recycle material such that reclaim material 614 may be intermingled with the new material and recycle material to give the build material 630 provided for the build platform 668. Further, the first conveying system 608 may also receive the recovered material 612 from the build enclosure 670 bypassing the reclaim vessel 688, as indicated by reference number 613. Moreover, as discussed, the 3D printer 600 may rely on the first conveying system 608 to divert the reclaim material 614 (or recovered material 612) through the diverter valve 632 to the recycle material vessel 622 and/or the recycle material cartridge in the recycle cartridge receiver 620. Lastly, the vessels, conveying systems, and associated equipment may include instrumentation such as pressure sensors and temperature sensors, and so forth.

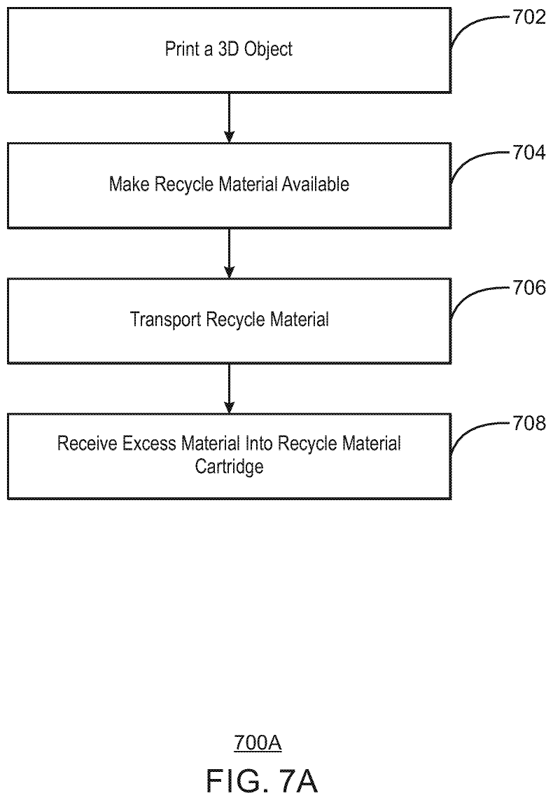

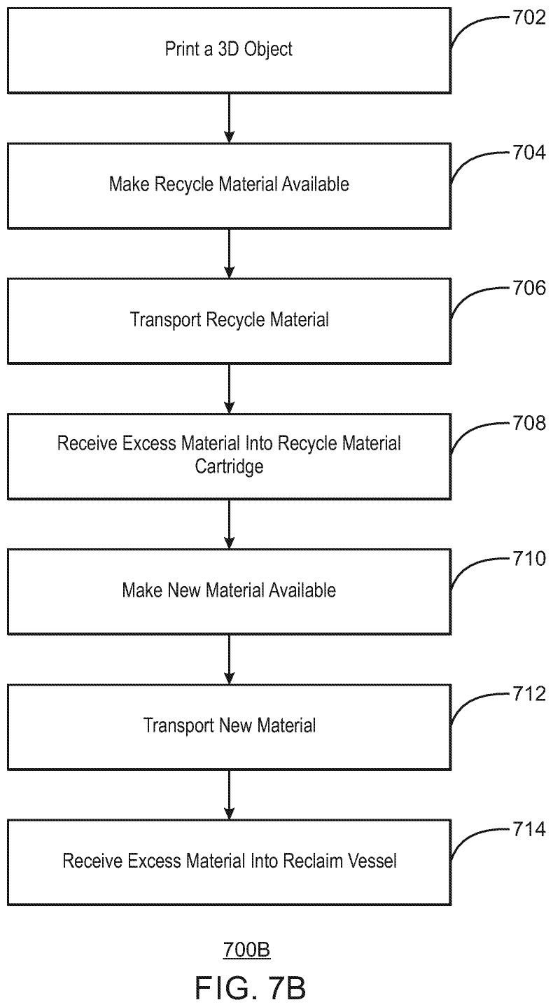

FIG. 7A is a method 700A of operating a 3D printer to form a 3D object. At block 702, the method includes printing a 3D object from feed material that may include recycle material. The recycle material may be excess material that is unfused or otherwise not incorporated into the 3D object during 3D printing. At block 704, the method includes making available recycle material from a recycle material cartridge for the printing. Alternatively, or in addition, the 3D printer may provide recycle material from a recycle material vessel or from a reclaim vessel. In one example for certain operations or configurations, a reclaim vessel may receive excess build material from within the 3D printer from the 3D printing, and the recycle material for the 3D printing may be sourced from the reclaim vessel with less or no recycle material from the recycle material cartridge or the recycle material vessel.

The recycle material cartridge may be disposed or inserted into an integrated recycle cartridge receiver of the printer. In some examples, the recycle material vessel may be disposed below the recycle cartridge receiver and supplied by the recycle material cartridge in the recycle cartridge receiver. At block 706, the method includes transporting recycle material as feed material for the build platform. The recycle material may be transported by a pneumatic conveying system of the 3D printer. If employed, the pneumatic conveying system may transport the recycle material to a feed vessel or dispense vessel that supplies a build-material applicator or the build platform with recycle material. At block 708, the method includes receiving excess material from the printing of the 3D object into the recycle material cartridge in the recycle cartridge receiver. A second conveying system which may include a vacuum system withdraws the excess material from the build enclosure where the 3D object is formed on the build platform. In certain examples, the vacuum may be provided by a motive component of the second conveying system and associated with a reclaim vessel. The motive component may be a vacuum pump, blower, steam jet, venturi, or combinations thereof.

FIG. 7B is a method 700B of operating a 3D printer to form a 3D object. Blocks 702-708 in FIG. 7B are the same as blocks 702-708 in FIG. 7A. At block 710 of FIG. 7B, the method includes making available new material from a new material cartridge in the 3D printer. Alternatively, or in addition, the 3D printer may provide new material from a new material vessel. The new material cartridge may be disposed or inserted into an integrated new cartridge receiver of the printer. In some examples, the new material vessel may be disposed below the new cartridge receiver and supplied by the new material cartridge in the new cartridge receiver. At block 712, the method includes transporting the new material from the new material vessel via a pneumatic conveying system. The pneumatic conveying system mixes the new material and recycle material to form a feed material having a specified ratio of new material to recycle material. In a particular example, the feed material is 20% new material by weight and 80% recycle material by weight, yielding a weight ratio of 0.25. The feed material is conveyed to a build enclosure via the pneumatic conveying system.

At block 714, the method includes receiving excess material into a reclaim vessel from the build enclosure. Again, the 3D object is generated on the build platform from feed material. After completion of the printing of the 3D object, a vacuum system or other conveying system removes excess material from the build enclosure. In some examples, the excess material is transported from the build enclosure to a reclaim vessel. In one example, the excess material leaves the reclaim vessel and is intermingled with new material from the new material cartridge and/or from the new material vessel, and with recycle material from the recycle material cartridge and/or from the recycle material vessel. Such conveyance, transport, and mixing may be facilitated by the pneumatic conveying system.

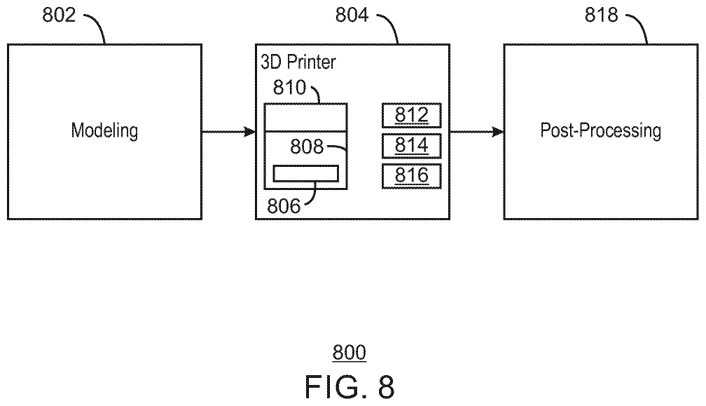

FIG. 8 is an AM system 800 which includes a modeling system 802 and a 3D printer 804. The 3D printer 804 may be analogous to one or more of the 3D printers depicted in the preceding figures. The AM system 800 may involve 3D printing performed by the 3D printer 804 as a materials printer using digital technology. In certain examples, the AM including 3D printing may form 3D solid objects from a digital model. Indeed, the AM system 800 may include the modeling system 802 to receive a model, prepare the received model, or generate a model, and the like, for AM and 3D printing. The model may be a 3D model. Moreover, the model may be “sliced” in preparation for the layer-by-layer printing. Digital data may be obtained from electronic data sources other than a model.

The model or other electronic source may provide digital 3D design data for the AM 3D printer 804 to build a component or product in layers by depositing material and fusing, sintering, melting, solidifying, etc., portions of the material. Such AM may be in contrast to milling a workpiece from a solid block, for example. The AM 3D printer relying on the model may build the product layer-by-layer employing materials, for example, in powder form. A range of different metals, plastics, and composite materials may be used. Unlike subtractive manufacturing techniques that start with a solid block of material and then cut away the excess to create a finished part, AM may build a part layer-by-layer from geometry described in a 3D design model. Of course, subtractive manufacturing (e.g., subtractive machining) may be employed in conjunction with AM in certain examples.

The AM system 800 includes one or more printers 804 to print (fabricate) the 3D solid object. The solid object may be a product which may be a complete product, a part of a product, a prototype, and so on. Again, 3D printing or AM may make 3D solid objects from a digital file. An object may be created by laying down successive layers of material until the object is created. In some instances, each of these layers can be seen as a thinly sliced horizontal cross-section of the eventual object. The 3D printing may involve sintering, melting, fusing, or fusion of the material or powder by energy sources such as a laser, electron beam, light, ultraviolet light, heat, and so forth. The 3D printing may involve other AM printing techniques.

In the illustrated example, the 3D printer 804 includes a build surface or build platform 806 on which the 3D object is printed and formed from material including powder. The build platform 806 is associated with a build enclosure 808. New powder and recycle powder may be fed to the build platform 806 for fabrication of the 3D object. Further, the 3D printer 804 includes a selective solidification module 810 adjacent to and above the build enclosure 808. The selective solidification module 810 performs the fusing, sintering, melting, solidifying, etc. that generates the 3D object. The 3D printer 804 includes a cartridge receiver 812 to hold a removable material cartridge that accepts excess build material from the build enclosure 808 and makes build material available to the build platform 806. Material may be moved through the 3D printer 804 by two or more conveying systems. The first conveying system 814 transports build material to a build-material applicator adjacent to or above the build enclosure 808. The build-material applicator may include a feed apparatus and a powder spreader. The second conveying system 816 recovers excess build material from the build enclosure 808 via a vacuum or other conveying technique.

The AM system 800 may include a post-processing system 818 to perform finishing or other processing of the 3D object. The post-processing system 818 may involve support removal, powder removal, sanding, vapor smoothing, painting, electroplating, metal-machining, polishing, and the like.

While the present techniques may be susceptible to various modifications and alternative forms, the examples discussed above have been shown by way of example. It is to be understood that the techniques are not intended to be limited to the particular examples disclosed herein. Indeed, the present techniques include all alternatives, modifications, and equivalents falling within the scope of the present techniques.

What is claimed is:

1. A three-dimensional (3D) printer comprising:
a cartridge receiver to hold an operationally-removable material cartridge to accept build material into the material cartridge from the 3D printer and to make available build material from the material cartridge for a build platform associated with a build enclosure;
a first conveying system to transport build material to a build-material applicator for the build platform; and
a second conveying system to recover excess build material from the build enclosure.

2. The 3D printer of claim 1, wherein the first conveying system comprises:
a motive component to provide a motive force on conveying fluid flowing through the first conveying system to transport build material to a separator;
the separator to separate the conveying fluid from the build material and discharge the conveying fluid to the motive component; and
a dispense vessel to receive the build material from the separator and provide the build material for the build-material applicator to apply the build material across the build platform.

3. The 3D printer of claim 2, comprising:
the build enclosure and associated build platform to form the 3D object from build material, wherein:
the separator comprises a cyclone;
the motive component comprises a blower, and wherein the conveying fluid comprises air; and
the build-material applicator comprises a powder spreader.

4. The 3D printer of claim 2, comprising:
a vessel to receive build material from the material cartridge held by the cartridge receiver;
a feeder to provide build material from the vessel to the first conveying system for transport of the build material to the separator, wherein the feeder to discharge build material into the conveying fluid in a conduit of the first conveying system, and wherein the build material comprises powder;
a weight sensor or level sensor, or both, associated with the vessel; and
a reclaim vessel to receive the excess build material from the second conveying system.

5. The 3D printer of claim 1, wherein the second conveying system comprises:
a manifold to receive the excess build material from the build enclosure;
a motive component to provide motive force for a conveying fluid to transport the excess build material from the manifold to a separation system;
the separation system to separate the conveying fluid from the excess build material and discharge the conveying fluid to the motive component; and
a vessel to receive the excess build material from the separation system.

6. The 3D printer of claim 5, comprising a printbar to eject print liquid onto build material on the build platform to form the 3D object, wherein the motive component comprises a blower, and wherein the conveying fluid comprises a gas.

7. The 3D printer of claim 1, wherein the material cartridge comprises a recycle material cartridge, wherein the cartridge receiver comprises a recycle cartridge receiver to hold the recycle material cartridge to receive the build material as recycle material into the recycle material cartridge and to make available recycle material from the recycle material cartridge as build material, and wherein the 3D printer further comprises a new cartridge receiver to hold an operationally-removable new material cartridge to make available new material from the new material cartridge as build material.

8. The 3D printer of claim 7, comprising:
a new material vessel to receive new material from the new material cartridge held by the new cartridge receiver;
a first feeder to receive new material from the new material vessel and discharge the new material as build material to the first conveying system;
a recycle material vessel to receive recycle material from the recycle material cartridge held by the recycle cartridge receiver; and
a second feeder to receive recycle material from the recycle material vessel and discharge the recycle material as build material to the first conveying system.

9. A three-dimensional (3D) printer comprising:
a selective solidification module to selectively solidify portions of successive layers of build material on a build platform to form a 3D object;
a cartridge receiver to hold an operationally-removable material cartridge to accept build material into the material cartridge from the 3D printer and to make available build material from the material cartridge for the build platform;
a pneumatic conveying system to transport build material for the build platform, wherein the pneumatic conveying system comprises a separator to separate conveying fluid from build material; and
a vacuum system to recover excess build material from a build enclosure associated with the build platform.

10. The 3D printer of claim 9, comprising:
a new cartridge receiver to hold an operationally-removable new material cartridge to make available new material as build material for the build platform; and
a powder spreader to distribute build material across the build platform, wherein the selective solidification module comprises a printbar to eject print liquid onto build material on the build platform to form the 3D object, and wherein the separator comprises a cyclone.

11. The 3D printer of claim 9, comprising:
a build unit processing module to separate the 3D object from excess build material; and
a recovery zone to recover the 3D object separated from the excess build material, wherein the vacuum system comprises a manifold to receive excess build material from the build enclosure, and wherein the vacuum system further comprises a separation system to separate air from the excess build material recovered.

12. A method of operating a three-dimensional (3D) printer, comprising:
printing a 3D object from feed material on a build platform;
making available recycle material as feed material from a recycle material cartridge in the 3D printer;
making available new material as feed material from a new material cartridge in the 3D printer, wherein the feed material on the build platform comprises a specified ratio of new material to recycle material;
transporting, via a pneumatic conveying system of the 3D printer, the feed material for the build platform; and
receiving excess material into the recycle material cartridge in the 3D printer from the printing of the 3D object.

13. The method of claim 12, wherein transporting, via the pneumatic conveying system, comprises:
transporting the recycle material and transporting the new material;
combining the recycle material and the new material as feed material having the specified ratio;
flowing conveying air via a blower; and
separating, via a cyclone, the conveying air from the feed material, wherein transporting the feed material comprises discharging the feed material from the cyclone into a feed vessel and discharging the feed material from the feed vessel for the build platform.

14. The method of claim 13, wherein making available recycle material comprises discharging recycle material from the recycle material cartridge to a recycle vessel, wherein transporting recycle material comprises transporting, via the pneumatic conveying system, recycle material discharged from the recycle vessel, wherein making available new material comprises discharging new material from the new material cartridge to a new material vessel, and wherein transporting new material comprises transporting, via the pneumatic conveying system, new material discharged from the new material vessel.

15. The method of claim 14, comprising receiving, via a vacuum system, excess material into a reclaim vessel from a build enclosure associated with the build platform, wherein transporting recycle material comprises transporting recycle material from the recycle material vessel to a dispense vessel for the build platform, wherein transporting new material comprises transporting new material from the recycle material vessel to the dispense vessel for the build platform, and wherein the method further comprises applying feed material to the build platform.
